(19) United States
(12) Patent Application Publication
(10) Pub. No.: US 2024/0047676 A1
(43) Pub. Date: Feb. 8, 2024

(54) SYSTEMS AND METHODS FOR SYNERGISTIC ENHANCEMENT OF LI-AIR BATTERY CAPACITY USING CNC/MWCNT COMPOSITES

(71) Applicant: The George Washington University, Washington, DC (US)

(72) Inventor: Michael Wagner, Rockville, MD (US)

(21) Appl. No.: 18/230,547

(22) Filed: Aug. 4, 2023

Related U.S. Application Data
(60) Provisional application No. 63/395,094, filed on Aug. 4, 2022.

(51) Int. Cl. H01M 4/583

(52) U.S. Cl. CPC H01M 4/583; H01M 2004/028

(57) ABSTRACT

Systems and methods are disclosed for a method of production of carbon nanochain, for use as cathodes, either alone or in combination with multi-walled carbon nanotubes. The carbon nanochain precursors are heated in the presence of inert atmosphere to synthesize the carbon nanochains. The carbon nanochains have high gravimetric and volumetric capacity and good cycle life when used as cathodes in Li—O₂ batteries. The performance of Li—O₂ battery cathodes comprised of mixtures of carbon nanochains and multiwalled carbon nanotubes is dramatically improved relative to cathodes comprised of either material in the absence of the other.

### CROSS-REFERENCE TO RELATED APPLICATIONS

This application claims the benefit of U.S. Provisional App. No. 63/395,094, filed Aug. 4, 2022, the entire contents of which are incorporated herein by reference.

### STATEMENT REGARDING FEDERALLY FUNDED RESEARCH

This invention was made with government support under NRO, Grant No. NR0000-14-C-0335. The government has certain rights in the invention.

### FIELD OF THE INVENTION

The present invention is directed to devices and methods for improving battery capacity and performance.

### BACKGROUND OF THE INVENTION

Global energy needs are predominately met by the burning of fossil fuels, resulting in the yearly emission of 33 gigatons of CO₂ equivalents. The transportation sector alone is responsible for more than 20% of these emissions. Therefore, transitioning transportation to clean energy is critical in reducing CO₂ emissions. Carbon neutral or negative, renewable production of electricity and the adoption of electric vehicles (EVs) are important steps towards achieving this goal. Most countries, including the US, aren't predicted to achieve 50% EV penetration until after 2035.⁴ Thus, CO₂ emissions produced by the transportation sector are expected to continue to increase until 2050 before reductions are seen globally. Increasing the rate of EV penetration into the automobile market could reduce further increases in CO₂ emissions and shorten the length of time before a reduction of CO₂ emissions from the transportation sector is achieved. However, several factors stand in the way. The range of current EVs meet the majority the day-to-day needs of consumers' travel demands, however, they still fall short in some circumstances resulting in ‘range anxiety’ for many consumers. This issue is exacerbated by under-developed charging infrastructure. Finally, high battery costs result in EV purchase prices that are significantly more than those of conventional vehicles. Thus, in order to increase the rate of penetration into the market, EVs need to possess longer driving ranges and become cheaper, in combination with other factors like improved charging infrastructure. Electrification of air transportation is even more challenging, requiring batteries with much larger capacities and higher power densities than Li-ion batteries (LIBs).

LIBs have allowed EVs to get a foothold in the automotive market due to their increased specific energies, energy densities, higher power density, and long cycling lifetimes compared to previous battery technologies such as lead-acid and nickel metal hydrides batteries.⁷ Since the adoption of LIBs in EVs in the early 2000s the rate of EV penetration into the automobile market has increased drastically. Between 2009 and 2019 the number of EVs on the road grew from a few thousand to 7.5 million globally.⁸ However, current LIB energy densities, 250-270 Wh/kg, still fall short of what is required to fully development the market, and far short of that required for aviation.

The power requirements of commercial planes are estimated to be between 600-1280 Wh/kg depending on the type of plane and distance being travelled. LIBs fail to come close to even the low end of these energy requirements. In addition, LIBs are expensive, with prices still around $119 per Wh. Just over a third of this cost is due to that of the cathode material, which contains valuable metals such as nickel and cobalt. Not only are these metals expensive, but due to the increasing production of Li-ion batteries, the demand for these materials is increasing significantly and supply risks, particularly for cobalt, are predicted. Finally, these metals are toxic raising the need for safe disposal or recycling of used Li-ion batteries. Current recycling processes, though, are costly, time-consuming, require the use of harsh chemicals, and have low material recovery efficiencies. To overcome these limitations new battery chemistries need to be explored and developed.

Lithium-oxygen batteries (Li—O₂) are a promising battery chemistry with superior theoretical energy densities (˜3500 Wh/kg) and, when employing carbon cathodes, low cost, making their development highly desirable. The capacity of Li—O₂ batteries has been found to be correlated to the carbon cathode pore structure, resulting in recent interest in carbons with high surface area and large pore volumes. Among these carbon materials, carbon blacks have come to be commonly studied. However, carbon blacks, being highly amorphous, are rich in defects. These defects are active sites for unwanted side reactions with the superoxide ion intermediate and rapid degradation of the cathode, resulting in short cycles lives. Cathodes made with carbon nanomaterials possessing ordered structures, such as multiwalled carbon nanotubes (MWCNTs), are more resistant to degradation, while still possessing high surface areas and large pore volumes, resulting in excellent performance. In addition, MWCNT's support nanoparticle catalysts such as platinum. However, the highly pure MWCNTs required for use in Li—O₂ cells are prohibitively expensive and their production is environmentally deleterious. Thus, cheap carbon nanostructures possessing similarly ordered structures with high surface areas, large pore volumes and pore sizes allowing for the facile transport of oxygen through the cathode are desirable for Li—O₂ batteries.

### SUMMARY OF THE INVENTION

In certain embodiments, the technology comprises carbon nanochains synthesized from a cellulose or lignocellulose source, metal salt (e.g. iron, cobalt, nickel, copper or other transition metal halides or other salts); and optionally a solvent to effect more efficient mixing of the materials (e.g. water). The cellulose or lignocellulose source and metal salt are heated in the presence of inert atmosphere to synthesize the carbon nanochains, and the carbon nanochains are isolated (e.g. filtration, centrifuge, drying etc). The carbon nanochains are porous with an average pore diameter ranging from 1-200 nm.

In other embodiments, the carbon nanochain is formed into a cathode.

In other embodiments, the carbon nanochain has an average pore diameter ranging from 1-100 nm.

In certain other embodiments, the technology comprises a cathode comprised of one or more carbon nanochains as well as one or more multi-walled carbon nanotubes. The combined cathode exhibits an increased discharge capacity and cycle life compared to cathodes formed from either carbon nanochains or multi-walled carbon nanotubes without the presence of the other.

### BRIEF DESCRIPTION OF THE DRAWINGS

A more complete appreciation of the technology and many of the attendant advantages thereof will be readily obtained as the same becomes better understood by reference to the following detailed description when considered in connection with the accompanying drawings, wherein:

FIG. 1A is an electron microscope images of carbon nanochains (CNCs) made from cellulose using 0.1 wt % FeCl₂ in the tube furnace obtained with SEM with inset showing CNC wall structure

FIG. 1B is an electron microscope images of CNCs made from cellulose using 0.1 wt % FeCl₂ in the tube furnace obtained with TEM with inset showing CNC wall structure;

FIG. 2 is an XRD diffractogram obtained with CNCs made from cellulose using 0.1 wt % FeCl₂ in the tube furnace where the inset shows the asymmetric fronting of the d˜0.34 nm reflection;

FIG. 3A is a graph showing pore diameter distributions of CNCs made from sawdust and cellulose in both the tube furnace and laser using 0.1 wt % FeCl₂

FIG. 3B is a graph showing pore diameter distributions of CNCs made from cellulose in the tube furnace;

FIG. 4 is a graph showing with the full depth of discharge capacity voltage profiles for CNC cathodes with varying weighted average pore diameters;

FIG. 5A is a graph showing the discharge capacity vs. pore volume of CNC cathodes;

FIG. 5B is a graph showing the discharge capacity vs. pore diameter of CNC cathodes;

FIG. 6 is a graph showing limited depth of discharge cycling performance of CNC samples showing increasing cycle life with increasing pore diameter and volume;

FIG. 7A is an SEM image showing a pristine MWCNT cathode;

FIG. 7B is an SEM image showing a pristine CNC cathode;

FIG. 7C is an SEM image showing a fully discharged MWCNT cathode;

FIG. 7D is an SEM image showing a fully discharged CNC cathode;

FIG. 8A is a graph showing full depth of discharge capacity of CNC (made from cellulose in tube furnace with 1 wt % FeCl₂) and MWCNT cathodes;

FIG. 8B is a graph showing cycling lifetimes of CNC (made from cellulose in tube furnace with 1 wt % FeCl₂) and MWCNT cathodes;

FIG. 9A is an SEM image of MWNCT cathodes prior to discharge;

FIG. 9B is an SEM image of mixed CNC and MWCNT cathodes prior to discharge;

FIG. 9C is an SEM image of CNC cathodes prior to discharge;

FIG. 10 is a graph showing the surface area as a function of CNC mass fraction;

FIG. 11 is a graph showing the average pore diameter as a function of CNC mass fraction;

FIG. 12 is a graph showing the porosity as a function of CNC mass fraction;

FIG. 13A is an SEM image of MWNCT cathodes after discharge;

FIG. 13B is an SEM image of mixed CNC and MWCNT cathodes after discharge;

FIG. 13C is an SEM image of CNC cathodes after discharge;

FIG. 14 is a graph showing Li—O₂ gravimetric storage capacity as a function of CNC mass fraction in MWCNT/CNC composite cathodes; and

FIG. 15 is a graph showing Li—O₂ volumetric storage capacity as a function of CNC mass fraction in MWCNT/CNC composite cathodes.

### DETAILED DESCRIPTION OF THE PREFERRED EMBODIMENTS

In describing a preferred embodiment of the technology illustrated in the drawings, specific terminology will be resorted to for the sake of clarity. However, the technology is not intended to be limited to the specific terms so selected, and it is to be understood that each specific term includes all technical equivalents that operate in a similar manner to accomplish a similar purpose. Several preferred embodiments of the technology are described for illustrative purposes, it being understood that the technology may be embodied in other forms not specifically shown in the drawings.

Carbon nanochains (CNCs) are carbon nanostructures with a chain-like morphology of interconnected multilayered carbon nano-onions in a stacked-cup CNT structure with pronounced exterior wall curvature. CNCs possess moderate surface areas and pore volumes and their synthesis was previously reported by chemical vapor deposition (CVD) and their potential as electrode materials for supercapacitors has been investigated. Certain methods for the formation of CNCs are described in U.S. Pat. Pub. No. 2022/0089445 A1, which is incorporated by reference in its entirety.

However, the use of CNC's as the cathode material in Li—O₂ batteries, and their synthesis by the method disclosed herein, has not previously been investigated. This disclosure presents the environmentally benign, carbon-negative, synthesis of carbon nanochains (CNCs) from lignocellulose or cellulose, using a metal salt catalyst, and heating, and their excellent performance as cathode materials, either with or without the additional presence of multiwalled carbon nanotubes, in Li—O₂ batteries. Formation of CNCs, as described herein, is performed by mixing cellulose or lignocellulose with metal salt (Fe, Co, Ni, Cu or other transition metal with halides or other anions) and heating to form the CNCs.

### Example 1: CNC Synthesis

Materials

All materials are used as received unless stated otherwise. Sawdust (System Three Resin Inc Wood Flour) and cellulose (FMC BioPolymer) were used as the biomass starting materials. Iron (II) chloride tetrahydrate used as the catalyst was purchased from STREM (99%, product no. 93-2632). Nitric acid purchased from Millipore Sigma (GR ACS, product no. NX0409-2) was used for CNC purification. LiNO₃ from Alfa Aesar (99.98% metal basis, product no. 10985), and dimethyl sulfoxide (DMSO) from Fischer (99.9%, product no. D139-1) were used to make the electrolyte. Multi-walled carbon nanotubes (>95 wt %, SKU #030103), 10-20 nm in diameter and 10-30 μm in length, were purchased from Cheaptubes.com. Carbon Fiber Paper (Porous C)-EQ-bcgdl-1400S-LD and coin cells (CR2016) were purchased from MTI Inc. Whatman glass microfiber filters (Grade GF/D, CAT no. 1823-150) were purchased through Millipore Sigma.

CNC Synthesis

Sawdust (System Three Resin Inc Wood Flour) or cellulose (FMC BioPolymer) was mixed with FeCl₂·4H₂O (99%, Strem Chemicals), the wt % calculated on FeCl₂ basis, with total mass of 8 g and loaded into a hardened steel cup (80 mL, Fritsch GmbH) with ten balls (hardened steel, 1 cm diameter) and milled at 300 rpm for 30 minutes using a planetary ball mill (Pulverisette 6, Fritsch GmbH). The FeCl₂ impregnated sawdust or cellulose was then pressed at 11,000 lbs (35,500 PSI, Carver 3851 benchtop laboratory press) into a 20 mm diameter pellet.

CNC Synthesis using Tube Furnace: Pellets were placed inside a quartz tube inside a Thermo Scientific Lindberg/Blue M TF55030A tube furnace and centered so that pellets sat in the middle of the furnace. Argon gas was flowed through the quartz tube at 150 mL/min for several minutes before heating to allow the gas flow to stabilize. The pellets were then heated to 1000° C. at 10° C./min and held at this temperature for 20 minutes. The pellets were then allowed to cool to room temperature while under the argon atmosphere in the tube furnace.

CNC Synthesis using Laser: A 21/64″ hole was drilled in each pellet using a Ryobi drill (DP102L benchtop). The pellets were then charred by placing them in a quartz tube inside a Thermo Scientific Lindberg/Blue M TF55030A tube furnace and centered so that pellets sat in the middle of the furnace. Argon gas was then flowed through the quartz tube at 150 mL/min for several minutes before heating, to allow the gas flow to stabilize. The pellets were then heated to 400° C. at 10° C./min and held for 20 min. After charring the pellets were stacked on a ¼″ stainless-steel rod and placed vertically in a four-way cross chamber. The rod was secured to and fed into the chamber by a stepper motor (STM-23, Applied Motion Products) through a flange at the top of the cross that was equipped with an Ultra-torr vacuum fitting. The chamber was evacuated to 10⁻³ Torr and then kept at 0.5 Torr with flowing N₂ gas. The pellets were rotated for one full rotation (48 sec/rotation) while being irradiated through a ZnSe window (Design Research Optics) with a 10.6 μm CO₂ laser at (60 W, Firestar t60, Synrad Inc.) focused to a 2 mm diameter spot. Synthesis of CNC's using an ytterbium fiber laser model YLR-1000-MM-WC at 60 watts with wavelength of 1070 nm was also investigated. Samples made from the ytterbium fiber laser show smaller surface areas, pore volumes, and pore diameters than those made from the CO₂ laser.

Purification: After heating, the pellets were ground into powder with a mortar and pestle, suspended (10 mg/mL) in nitric acid (ACS grade, Millipore Sigma) and heated to reflux for 4 h to remove amorphous carbon. The CNCs were isolated by vacuum filtration, rinsed with distilled water and dried overnight at 120° C. CNCs were then further purified by microwave digestion (PreeKem WX-6000) in nitric acid (10 mg/mL) for 30 minutes at 180° C. Finally, the CNCs were isolated by vacuum filtration, rinsed with distilled water and dried overnight at 120° C.

Characterization: Thermogravimetric analysis (TGA) was performed using a Perkin Elmer Pyris 1 TGA. Scanning electron microscopy (SEM) and transmission electron microscopy (TEM) were obtained using a FEI Teneo LV FEG microscope and a FEI Talos™ F200X microscope, respectively. Powder X-ray diffractograms were obtained using a Bruker D2 Phaser x-ray diffractometer (Cu-Kα radiation). Raman spectra of the CNCs were obtained using LabRAM HR spectrometer using laser excitation wavelength of 532 nm.

Nitrogen adsorption isotherms were measured using a Micrometrics Tristar 3000 Surface Area and Porosity Analyzer. Prior to analysis, CNC samples were dried under vacuum at 150° C. for one hour followed by 350° C. for three hours using Micrometric VacPrep 061 sample degassing system. The surface area was calculated using the Braunauer-Emmet-Teller (BET) method, the pore volume and pore size distribution (PSD) was calculated using the Barrett-Joyner-Halenda method.

CNC Cathode Preparation: CNCs were suspended in isopropyl alcohol (IPA, VWR Chemicals 99.5%) and sonicated for 30 minutes to make a suspension with a CNC concentration of 9 mg/mL. Carbon fiber paper (CFP) current collectors (MTI Inc.), from which carbon black was removed by repeated sonication in IPA followed by abrasion, were placed in half of a CR2016 coin cell. The CNC solutions were drop cast onto the CFPs and the IPA was removed by evaporation. The cathodes were massed and when necessary, more CNC solution was drop cast onto the cathode until the target loading of 1.5 mg/cm² had been reached. The CNC cathodes were dried in a 120° C. oven overnight. The CNC cathodes were then pressed between two sheets of aluminum foil at 18,000 lbs (58,000 PSI).

MWCNT Cathode Preparation: MWCNTs were sonicated in IPA for 30 minutes to form a suspension with a concentration of 0.33 mg/mL. The suspension was then poured through CFP, from which carbon black had been removed, stacked on top of a PTFE membrane filter (47 mm diameter, 0.45 μm pore size, Simsii Inc.), leaving a layer of MWCNTs on top of the CFP. The sample was then dried at 120° C. overnight. Electrodes, 1.6 cm in diameter, were punched out of the film (MSK-T-07 Precision Disc Cutter, MTI Inc.) and pressed between two sheets of aluminum foil at 6,000 lbs (19,400 PSI). The loading of the MWCNT cathodes was ˜1.5 mg/cm².

Cell Assembly: Nine holes (1 mm diameter) were punched into the cathode side of coin cells (CR2016, MTI Inc.) to allow oxygen flow during cell cycling. The cells were assembled in an Ar filled glove box, using lithium metal chips (15.6 mm diameter and 0.45 mm thick, 99.9%, MTI Inc.) as the anode and glass microfiber filter (Grade GF/D, Whatman Inc.) as the separator saturated with 200 μL of 0.1 molar ratio LiNO₃ (99.98%, Alfa Aesar) and dimethyl sulfoxide (DMSO, 99.9%, Fisher Inc.) electrolyte.

Electrochemical Cell Testing: The cells were placed in air-tight custom-built PVC containers, purged with a flow of O₂ (99.995%, Robert's Oxygen Company) for 10 min, and then maintained at 5 psi. The cells were held for 4 hours at OCV and then cycled at a current density of 0.2 mA/cm². Cells were discharged from OCV (˜2.8-3.0 V) to 2.0 V to measure the maximum capacity that the CNC and MWCNT cathodes could achieve. Following the practice of previous studies, multicycle testing was performed with a limited depth of discharge (500 mAh/g discharge/charge) to avoid dendrite formation with CNC and MWCNT cathodes.

Results & Discussion

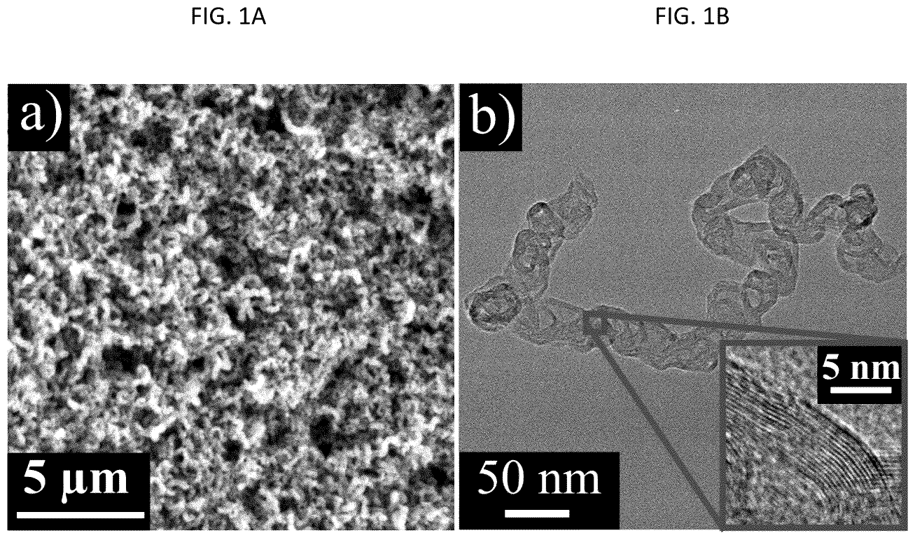

After purification, CNC samples consist primarily of “sponge-like” agglomerates of intertwined twisted tubes (FIG. 1A). In addition, numerous separated individual and small groups of CNCs are present. Prior to purification, unreacted starting material (biochar) is visible in SEM images. TGA thermograms run in air show a broad ˜100% mass loss with an onset temperature of 510° C. for the unpurified material. Purification results in a dramatically sharper mass loss event and a reduction in the onset temperature to 324° C.

The internal structure of CNC's is analogous to MWCNT's in that their walls consist of 10-15 layers of nested carbon sheets (FIG. 1). However, whereas the carbon sheets which comprise MWCNT's are concentric and ideally continuous along the entire length of each tube, the walls of CNC's periodically curve inward, forming a chain of interconnected ˜20-50 nm hollow carbon onions (CNO), similar to bamboo-like or stacked-cup structured CNTs, held together by shared walls. While TEM images show open passages between some adjacent onions, it is not clear if these openings extend the length of the chain. The chains are generally irregular spirals of several to 10's of μm in length.

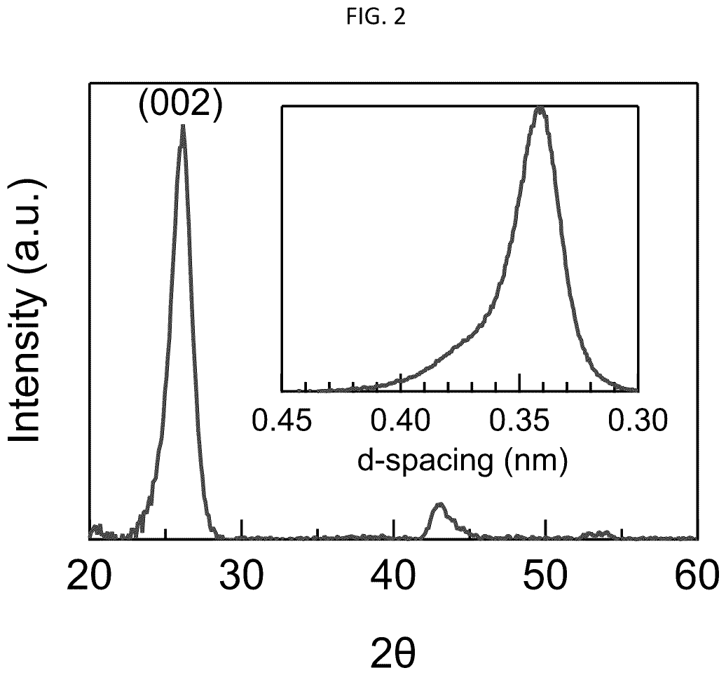

The interlayer wall spacings of the CNCs were measured by XRD (FIG. 2) and found to be in good agreement with TEM images, ˜0.341 nm regardless of starting material or heating method. However, the reflection is broad and asymmetric, extending as a shoulder to ˜0.40 nm. This breadth could be due to an additional phase, however, it seems more likely that it is due to differences in the interlayer spacing of the various wall segments of the CNCs, being relatively straight over some portions and curved to various degrees over others, variation in the wall spacing with CNC diameter⁴² or intrawall separation.⁴³ In addition, the shape of the reflection changes with increasing FeCl₂ content for samples made with cellulose, with a new peak growing in as a shoulder at lower d-spacing when made with 5 wt % FeCl₂. Deconvolution yields a peak with d˜0.335 Å in addition to that at ˜0.34 Å, consistent with the formation of a second, more graphitic phase. This second phase can be seen in SEM images, appearing to be μm and sub-μm flakes of graphite.

Raman spectra of the CNC's show the presence of both D and G bands at 1350 cm⁻¹ and 1589 cm⁻¹, respectively. The D-band results from the sp³ carbon present at edges while the G-band results from stretching vibrations of the plane of the sp² carbon sheets, referred to as the E_{2g} mode. The ratio of the peak intensities, ID/IG, is a measure of the frequency of defects in layered carbon structures, being nearly zero for highly crystalline graphite. The ID/IG ratio of CNC's, ranging from ˜1.6 to ˜1.45, indicating a low but increasing degree of order with increasing wt % FeCl₂, consistent with the highly curved nature of the carbon walls. The range of values observed are similar to those of CNTs with bamboo-like structure, with ID/IG ratios between 1.0 and 1.5.

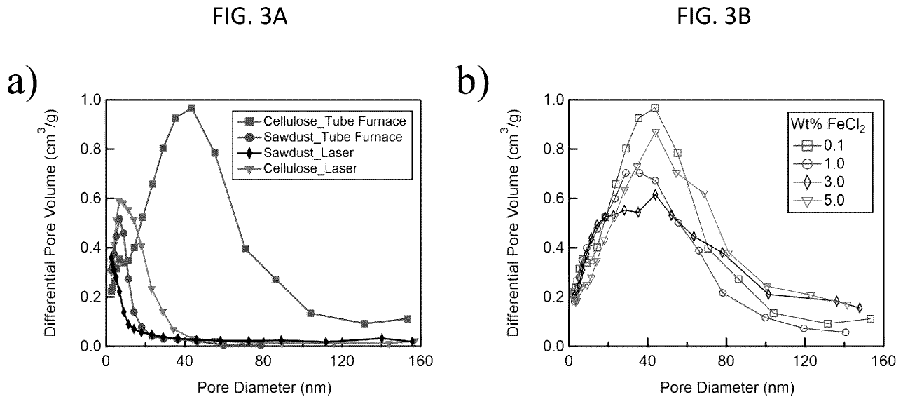

The pore structures of the CNCs depend on the starting material and the heating method far more so than the FeCl₂ content. CNCs display type V isotherms with H2(b) hysteresis loops, indicating a mesoporous material with pores having an ink bottle pore structure, in which a large central pore cavity is accessed through a smaller neck pore. The pore diameter distribution of CNCs made from cellulose are broader and extend to larger diameters than those made from sawdust. The peaks of the distributions are below 20 nm in all cases, consistent with the observed interior dimensions of the CNCs (FIG. 1), except those made from cellulose in the tube furnace (FIG. 3A and Table 1). It seems unlikely that the larger pore diameters are due to morphological differences in the CNC agglomerates as the volume of the exterior voids are generally of μm scale, however, nm scale pockets formed by the twisted morphology of the CNCs cannot be ruled out. Alternatively, more frequent openings connecting the interiors of adjacent CNO links in the chains could result in larger, combined pores, in agreement with the observed distributions, although it is unclear why this might occur. This phenomenon is largely independent of catalyst loading (FIG. 3B).

The surface area, total pore volume and weighted average pore diameters, summarized in Table 1, depend on the heating method, the type of biomass and catalyst loading used. Generally, the surface area of CNCs decreases with increasing catalyst loading, from ˜250 m²/g when using 0.1 wt % FeCl₂ and plateauing at around 200 m²/g with higher loading. However, the surface areas for CNCs made from cellulose are exceptional in that they present an anomalously low surface area when made with 0.1 wt % FeCl₂ (˜220 m²/g), rising to an anomalously high surface area with 1.0 wt % FeCl₂, and decreasing with catalyst higher loadings. The surface area of the CNCs made with cellulose are lower than those made from sawdust and 5.0 wt % FeCl₂, regardless of heating method, presumably due to the observed growth of a second (graphitic) phase as discussed above, resulting in an anomalously low surface area.

TABLE 1

| | | | | | Weighted |
|---|---|---|---|---|---|
| | | | Surface | Pore | Average |
| Heating | | Wt % | Area | Volume | Pore |
| Method | Biomass | FeCl₂ | (m²/g) | (cm³/g) | Diameter (nm) |
| Tube | Sawdust | 0.1 | 253.5 ± 13.2 | 0.39 ± 0.13 | 11 ± 6 |
| Furnace | | 1.0 | 208.5 ± 24.6 | 0.45 ± 0.15 | 15 ± 6 |
| | | 3.0 | 199.9 ± 19.1 | 0.53 ± 0.04 | 21 ± 5 |
| | | 5.0 | 202.4 ± 12.0 | 0.53 ± 0.07 | 20 ± 3 |
| | Cellulose | 0.1 | 241.3 ± 22.6 | 0.77 ± 0.1 | 32 ± 7 |
| | | 1.0 | 205.9 ± 26.1 | 0.74 ± 0.05 | 39 ± 8 |
| | | 3.0 | 189.6 ± 18.6 | 0.75 ± 0.06 | 40 ± 4 |
| | | 5.0 | 180.2 ± 8.1 | 0.60 ± 0.18 | 36 ± 8 |
| Laser | Sawdust | 0.1 | 247.2 ± 13.3 | 0.23 ± 0.02 | 13 ± 2 |
| | | 1.0 | 248.4 ± 15.7 | 0.41 ± 0.15 | 12 ± 6 |
| | | 3.0 | 195.2 ± 10.9 | 0.43 ± 0.08 | 22 ± 5 |
| | | 5.0 | 212.1 ± 17.5 | 0.51 ± 0.05 | 17 ± 2 |
| | Cellulose | 0.1 | 222.8 ± 42.4 | 0.30 ± 0.2 | 15 ± 2 |
| | | 1.0 | 266.6 ± 10.1 | 0.61 ± 0.13 | 18 ± 5 |
| | | 3.0 | 206.0 ± 22.0 | 0.50 ± 0.06 | 22 ± 4 |
| | | 5.0 | 136.8 ± 9.6 | 0.46 ± 0.02 | 34 ± 1 |

Surface area, while an important property of materials in many applications, is believed to play only a small role in determining the performance of Li—O₂ cathodes, while pore volume and pore diameter are believed to be critical. CNCs made from cellulose have larger total pore volumes than those made from sawdust at lower catalyst loadings, in particular those made in the tube furnace, decreasing to be nearly roughly equal with 5.0 wt % FeCl₂ (Table 1). Again, this decrease at high loadings may be at least in part due to the formation of a graphitic phase. Average pore diameters are significantly larger for CNC's made from cellulose in the tube furnace, matched by those made from cellulose with a laser at 5.0 wt % FeCl₂ (Table 1). Table 1 shows surface areas, pore volumes, and weighted average pore size of CNCs, organized by heating method, biomass starting material, and weight % FeCl₂. The highlighted samples were selected to make Li—O₂ cathodes.

CNC Cathode Performance

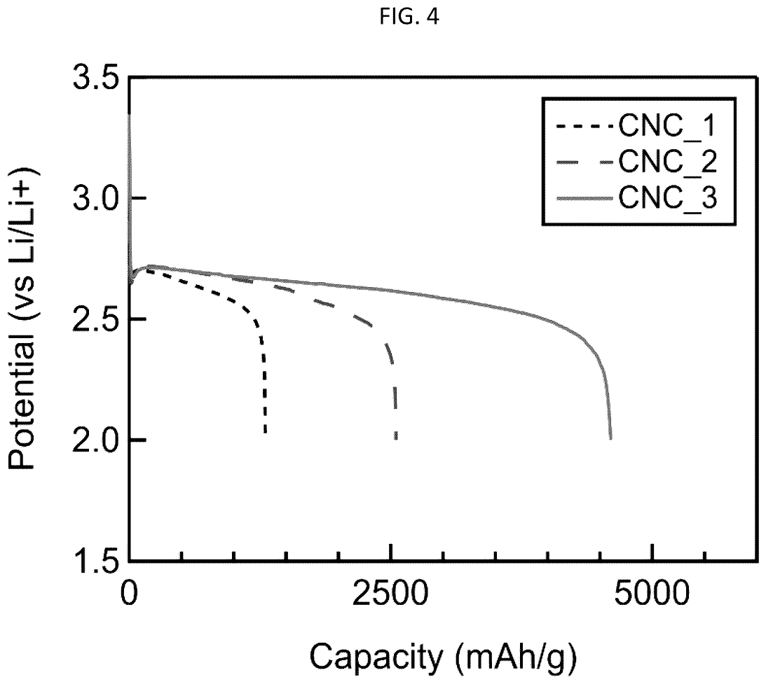

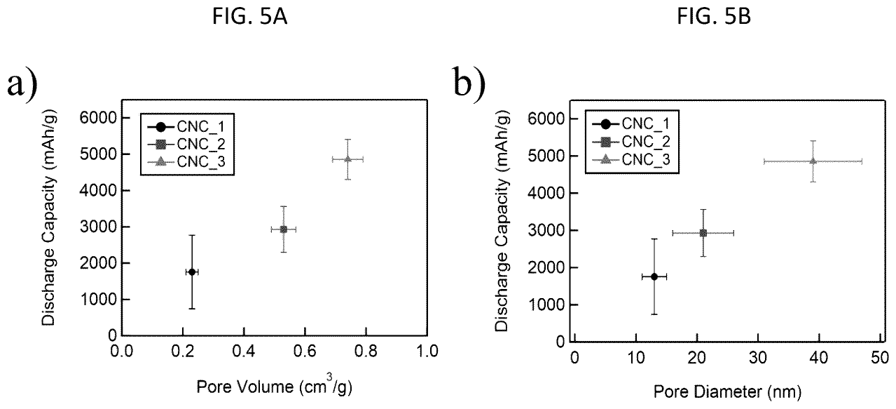

The full depth of discharge performance of Li—O₂ cathodes made from sawdust in the laser (0.1 wt % FeCl₂, CNC_1) and in the tube furnace (3 wt % FeCl₂, CNC_2), and cellulose in the tube furnace (1 wt % FeCl₂, CNC_3) is shown in FIG. 4. The CNC samples were chosen to span a wide range of surface areas (247, 200 and 206 m²/g), total pore volumes (0.23, 0.53 and 0.74 cm³/g) and average pore diameters (˜13 nm, 21 nm, and 39 nm), while avoiding preparations that resulted in the presence of a significant fraction of a second, graphitic phase. A previous study found that the discharge capacity of carbon cathodes increased with pore diameter but was insensitive to surface area and total pore volume. We also find that the discharge capacity of our carbon cathodes, CNCs, is not correlated to surface area but increases monotonically in a roughly linear or parabolic fashion with total pore volume, and pore diameter (FIG. 5B).

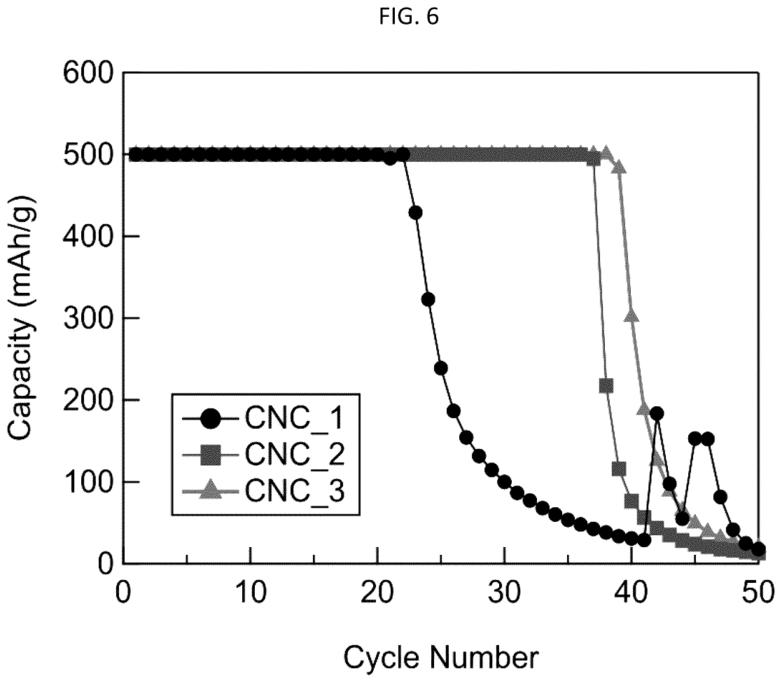

Attempting to recharge cells after full depth of discharge frequently resulted in the formation of dendrites and consequent cell short circuiting. Stable, safe cycling was achieved by limiting the depth of discharge to 500 mAh/g (˜3 times the gravimetric energy density, on an electrode materials basis, of Li-ion batteries), in agreement with previous studies. The charge/discharge profiles were largely identical for all three samples. However, increasing the average pore diameter from 11 to 21 nm dramatically increased the cycle life from 23 to 37 cycles (FIG. 6). Only 2 cycles were added by further increasing the pore diameter to 39 nm.

Comparison of MWCNT and CNC Cathodes

The structure of CNCs is in many respects similar to that of MWCNTs but they differ significantly in their surface area and porosity. The surface area of CNC_3 is more than 2 times and the pore volume 6% larger than MWCNTs, while the average pore diameter of MWCNTs is much greater than that of CNCs. In addition, CNCs have a larger total pore volume of pores less than 60 nm with a diminishing fraction as the pore diameter approaches 120 nm; the fraction of MWCNT pore volume grows roughly parabolically with increasing pore diameter.

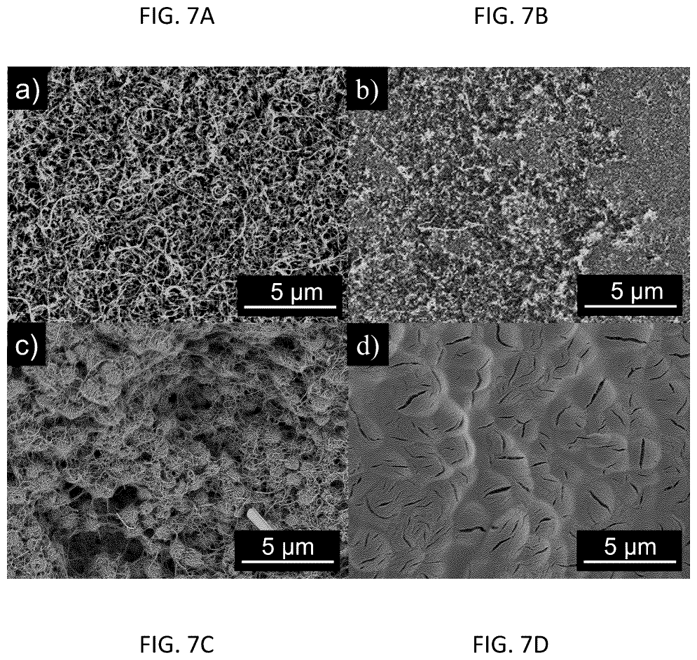

MWCNT cathodes have porous, fibrous surfaces (FIG. 7A). Discharge results in lithium peroxide toroidal particles forming in the interior, encapsulated by webs of nanotubes, with few or none on the electrode face. The particles grow upon further discharge until they are ˜1 μm in diameter. The particles never exhibit intergrowth, remaining distinctly individual rather than as a continuous mass, even after full discharge, and are predominately found in the interior, rather than the face, of the electrode (FIG. 7C). The fibrous network and high porosity that appears to span the depth of the electrode is still apparent. With no obvious limitations to reactant transport, it has been suggested that the surface passivation prevents further discharge.

The surfaces of CNC cathodes are relatively uniform (FIG. 7B). In the early stages of discharge, toroidal lithium peroxide particles are seen to be uniformly distributed on, but not completely covering, the surface of the CNC cathode. In addition, the electrode is seen to develop cracks in its surface, possibly due to stress caused by interior peroxide formation. With further discharge, the lithium peroxide particles grow until they are ˜2 μm in diameter, approximately twice the size observed with MWCNT electrodes, and almost completely coating the CNC cathode, but maintaining distinctly individual toroids. Full discharge results in further enlargement of the particles and their intergrowth, forming a continuous film (FIG. 7D). It seems likely that further discharge is prevented by the complete coating of the cathode surface, passivating it with an electrically insulating peroxide coating and/or preventing O₂ and Li⁺ transport. While beyond the scope of this study, our results suggest that further increasing the pore diameters of CNCs could allow for additional peroxide growth and thus larger capacity.

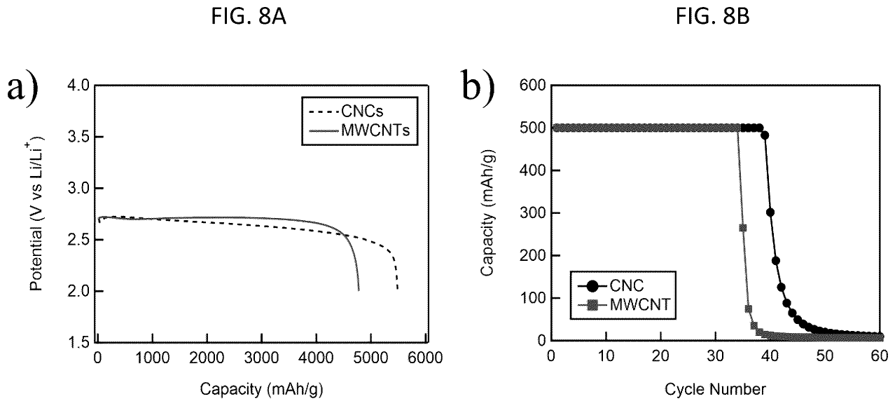

Despite the dramatic difference in the peroxide growth location and coverage, the gravimetric discharge capacities of MWCNT and CNC electrodes are nearly identical (FIG. 8A, Table 2), suggesting that the larger surface area and/or total pore volume of the CNCs compensate for their relatively small pore diameters. In addition, the CNC electrodes are far denser than those made with CNTs, yielding an average volumetric capacity that is more than twice as large.

Limiting the depth of discharge to 500 mAh/g resulted in stable cycling for the MWCNT as well as the CNC cathodes. The difference between the charge and discharge potentials was, within the limits of uncertainty, essentially identical, with CNC's generally exhibiting slightly higher charge and discharge potentials. The average cycle life of the CNCs cathodes is 19% longer than that of CNTs (FIG. 8B and Table 2).

TABLE 2

| | | | Weighted | Gravimetric | Volumetric | | |
|---|---|---|---|---|---|---|---|
| | | Pore | Average Pore | Discharge | Discharge | Discharge | Cycling |
| Cathode | Surface | Volume | Diameter | Capacity | Capacity | Overpotential | Lifetimes |
| Material | Area (m²/g) | (cm³/g) | (nm) | (mAh/g) | (mAh/cm³) | (mV) | (cycles) |
| CNCs | 205.9 ± 26.1 | 0.74 ± 0.05 | 39 ± 8 | 4858 ± 551 | 5113 ± 580 | 316 ± 17 | 38 ± 8 |
| MWCNTs | 93.7 ± 25.1 | 0.70 ± 0.06 | 77 ± 12 | 4619 ± 508 | 2333 ± 256 | 261 ± 13 | 32 ± 3 |

### CONCLUSIONS

CNCs, material structurally akin to MWCNTs, can be synthesized from biomass by simple, rapid methods. The properties of CNCs, including surface area, porosity and average pore diameters, can be rationally controlled by variations of the synthetic parameters. The surface areas of CNC's made from sawdust are higher than those made from cellulose using equivalent catalyst (FeCl₂) loading and heating method. The CNC pore structure is found to be dependent on the selection of starting material, heating method, and wt % of catalyst. Of note, CNCs made from cellulose in the tube furnace showed larger pore volumes and pore diameters than those made with a laser or sawdust by either heating method. Overall, CNCs could be made with pore volumes and average pore diameters ranging from 0.23-0.77 cm³/g and 11-40 nm, respectively, depending on the synthesis conditions selected.

The relationships between average pore diameters, total pore volume and surface area and Li—O₂ cathode performance were investigated by testing cathodes made with CNCs that widely differed in these characteristics. It was found that both full depth of discharge capacity and limited depth of discharge cycling lifetimes improved with increasing pore diameter and pore volume. Isolating the roles of pore diameter and pore volume was not possible because CNCs with larger pore diameters always resulted in larger pore volumes as well.

The Li—O₂ battery performance of cathodes made from CNCs perform modestly better than MWCNT cathodes both in terms of full depth of discharge gravimetric capacity and limited depth of discharge cycle life, despite MWCNTs possessing much larger average pore diameters than those of CNCs, while having only as a slightly smaller total pore volume. The lithium peroxide storage was found to grow far more densely on CNCs, the toroids merging to completely cover the cathode while those on MWCNTs remained distinctly separated upon full discharge. Furthermore, CNC cathodes are substantially denser than those of MWCNTs, resulting in more than twice the volumetric capacity for full discharge. Thus, CNCs are an environmentally benign alternative Li—O₂ cathode material, with superior performance to those made from MWCNTs, at a potentially much lower production cost.

### Example 2: Enhancing Li-Air Battery Capacity Using Mixed CNC/MWCNT Cathodes

Procedures/Results

Suspensions of mixtures of CNCs and MWCNTs, were prepared in IPA and sonicated for 30 minutes to ensure homogeneity. Mixed CNC/MWCNT cathodes were formed by pouring suspensions of mixtures of CNCs and MWCNTs through carbon fiber paper (CFP), from which carbon black had been removed, stacked on top Simsii PTFE membrane filter with 0.45 μm pore size in a filter funnel, leaving a layer of mixed CNCs and MWCNTs which in turn were on top of the CFP. The samples were then dried at 120° C. overnight. Electrodes, 1.6 cm in diameter, were punched out of the film and pressed between two sheets of aluminum foil at 6,000 lbs.

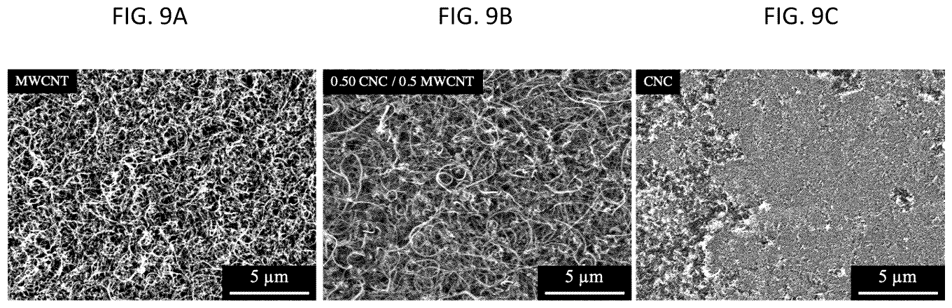

Scanning Electron Microscopy (SEM) images of the electrodes show that the CNCs are evenly distributed throughout the MWCNTs, as shown in FIGS. 9A through 9C, which show SEM images of MWNCT, mixed CNC/MWCNT. and CNC cathodes prior to discharge.

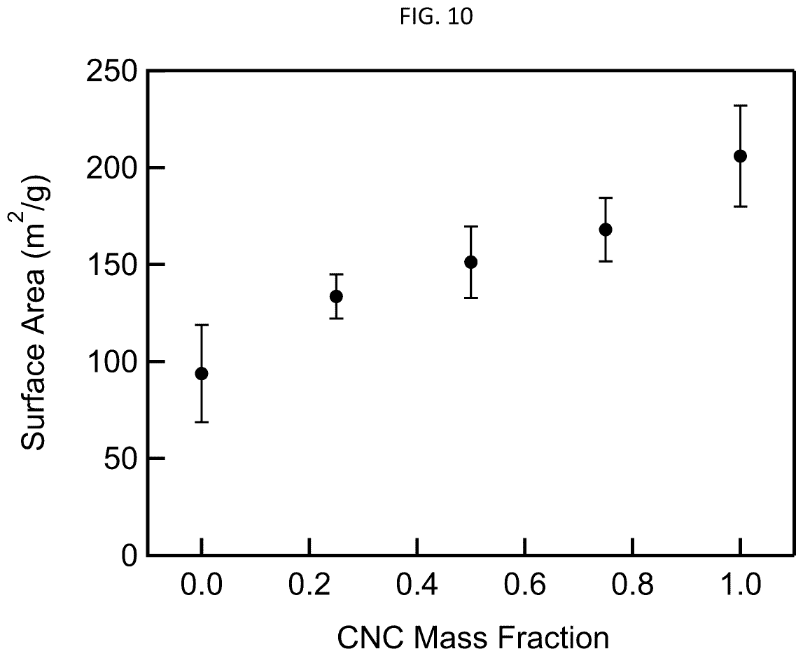

Isothermal gas adsorption measurements, conducted as described in the attached file, show that the gravimetric surface area of the cathodes increase with increasing CNC fraction (FIG. 10), as one might expect from a mixture of the two materials.

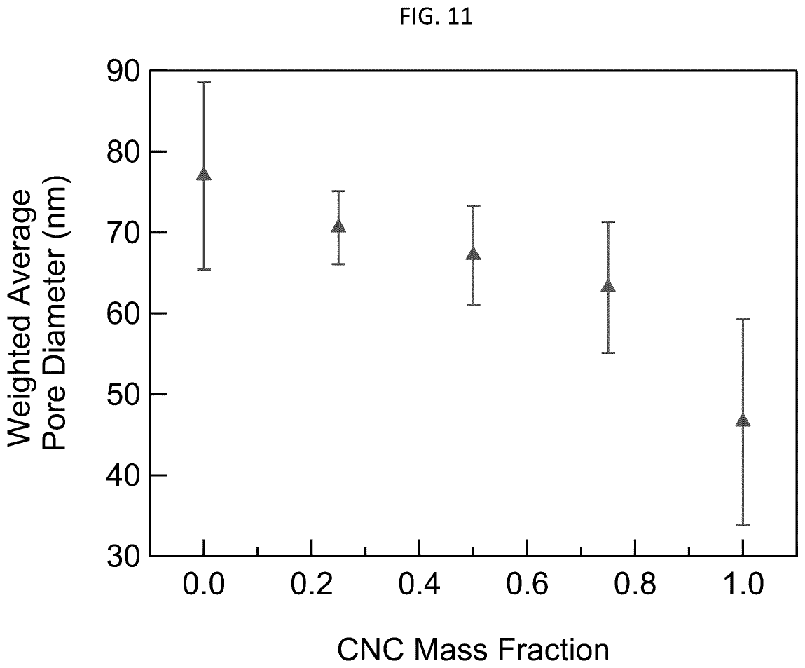

The average pore diameter is largest for the pure MWCNT and smallest for CNC cathodes, but surprisingly does not decrease linearly with increasing CNC fraction as one might expect for the mixture, remaining high as the CNC fraction is increased, with the 80% CNC/20% MWCNT cathode retaining ˜82% of the value (FIG. 11).

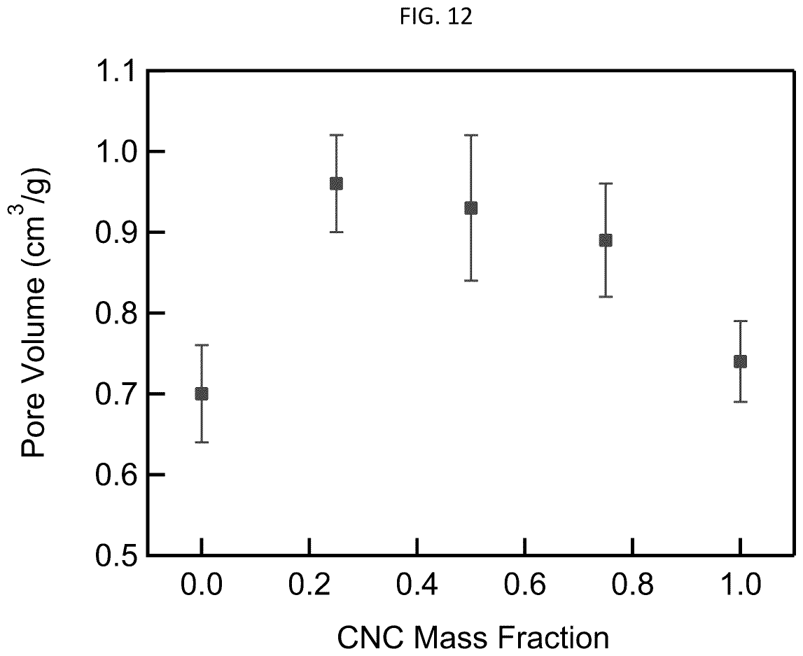

The total pore volume of pure CNC cathodes is higher than that of pure MWCNT cathodes, but is unexpectedly much higher, by as much as ˜25%, for the mixtures than the pure cathodes (FIG. 12).

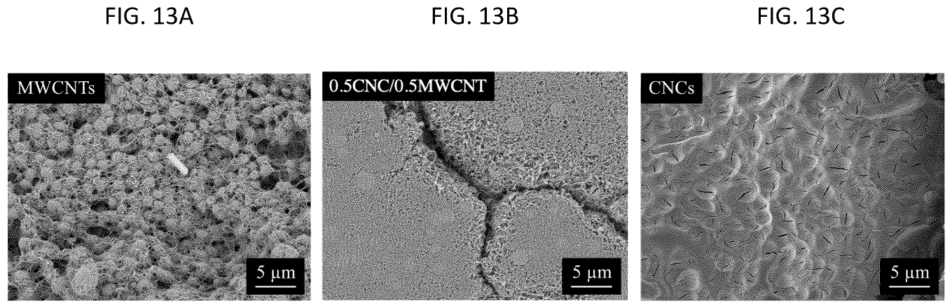

Electrochemical testing was performed as described in the above referenced file. Following discharge, the MWCNT cathodes (FIG. 13A) show enmeshed individual Li₂O₂ toroidal particles, while the CNC cathodes (FIG. 13C) display a thick, dense film of Li₂O₂ toroids. The mixed cathodes (FIG. 13B) show thicker, denser Li₂O₂ than those made with only MWCNTs (FIG. 13A).

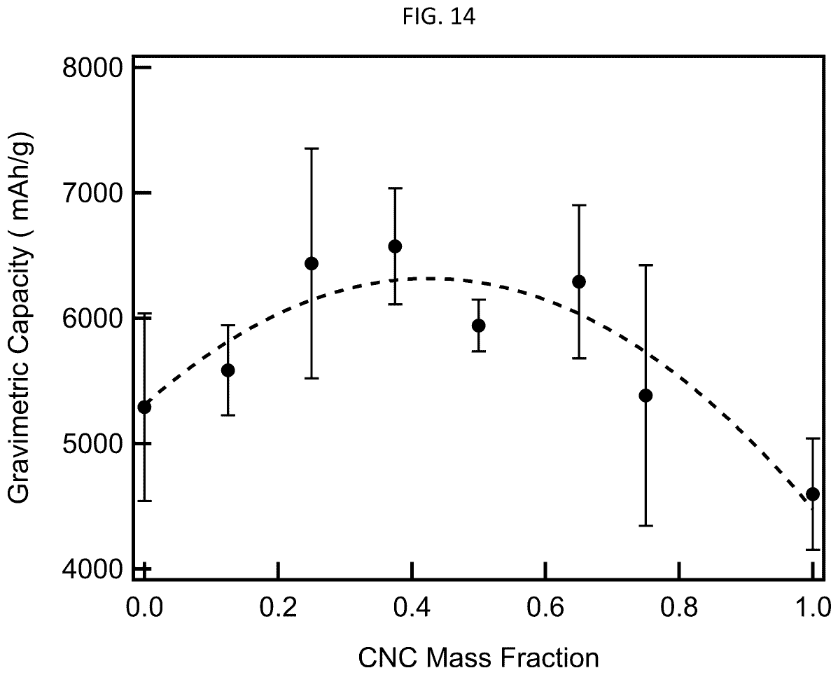

As shown in the graph below (FIG. 14), mixtures of CNCs and MWCNTs obtain dramatically higher discharge capacity than electrodes composed of solely MWCNTs (CNC fraction=0) or CNCs (CNC fraction=1). In fact, electrodes composed of a mixture of 25% CNCs and 75% MWCNTs obtained an average of more than 7200 mAh/g, ˜25% greater than either CNCs or MWCNTs alone.

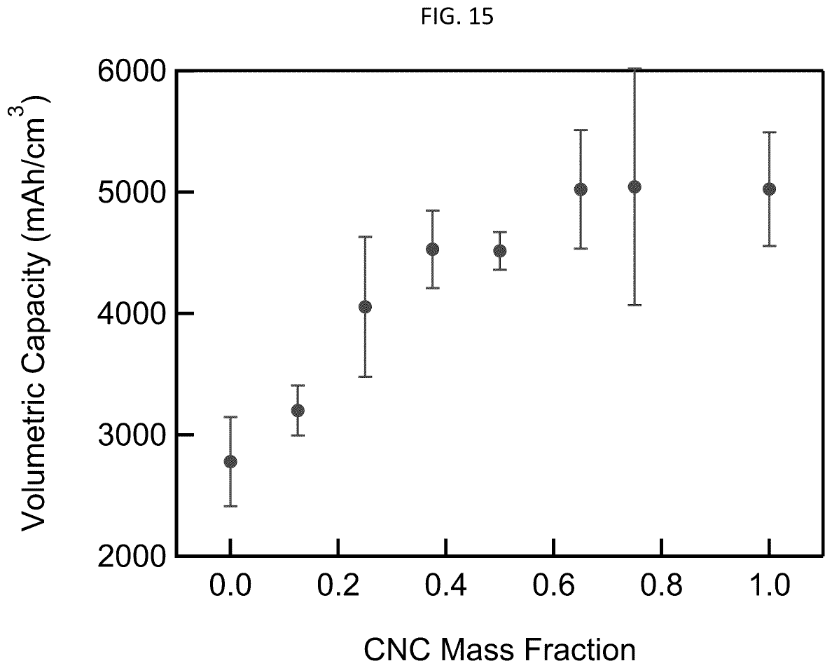

The increase in gravimetric capacity is accompanied by a retention of the very high volumetric capacity of pure CNC cathodes (FIG. 15), one useful battery performance measure.

While not being bound to any particular theory, the synergistic increase in cathode performance may be due to the unexpected increase in total pore volume and retention of relatively large pore diameters. Cathode performance is thought to be relatively independent of surface area, in agreement with the performance we observe for our cathodes. However, cathode performance is thought to be strongly dependent on the average pore diameter and total pore volume. We observe a greater retention of the average pore diameter of the MWCNT cathodes with our mixtures, and even more surprisingly, an increase in total pore volume beyond that of the pure cathodes in the mixtures. The interaction of the CNC's and MWCNT's, perhaps through mutual contact, creates additional porosity which could improve cathode capacity. In addition, the addition of CNC's changes the storage mechanism in the mixtures from the individual, enmeshed particles in a highly porous network of MWCNTs, to something more akin to that seen with pure CNC electrodes, a thick, dense layer. This results in the retention of very high volumetric, while greatly increasing the gravimetric, capacity in the mixed cathodes.

### REFERENCES

Zhang, M.; Zhao, N.; Sha, J.; Liu, E.; Shi, C.; Li, J.; He, C. Synthesis of Novel Carbon Nano-Chains and Their Application as Supercapacitors. J Mater Chem A 2014, 2 (38), 16268-16275. https://doi.org/10.1039/c4ta02623c.
Zhang, M.; He, C.; Liu, E.; Zhu, S.; Shi, C.; Li, J.; Li, Q.; Zhao, N. Activated Carbon Nanochains with Tailored Micro-Meso Pore Structures and Their Application for Supercapacitors. J Phys Chem C 2015, 119 (38), 21810-21817. https://doi.org/10.1021/acs.jpcc.5b05480.

The foregoing description and drawings should be considered as illustrative only of the principles of the technology. The technology is not intended to be limited by the preferred embodiment and may be implemented in a variety of ways that will be clear to one of ordinary skill in the art. Numerous applications of the technology will readily occur to those skilled in the art. Therefore, it is not desired to limit the technology to the specific examples disclosed or the exact construction and operation shown and described. Rather, all suitable modifications and equivalents may be resorted to, falling within the scope of the technology. All references cited herein are incorporated by reference in their entireties.

1. A method for forming a cathode comprising:
forming one or more carbon nanochains using a cellulose or lignocellulose source and a metal salt;
forming one or more multi-walled carbon nanotubes;
mixing the one or more carbon nanochains with the one or more multi-walled carbon nanotubes;
applying the mixture of carbon nanochains and the multi-walled carbon nanotubes to a surface to form a layer in which the carbon nanochains are distributed within or adjacent to the carbon nanotubes.

2. The method of claim 1, wherein the carbon nanochains have an average pore diameter ranging from 1-200 nm.

3. The method of claim 1, wherein the carbon nanochains are synthesized in a furnace.

4. The method of claim 1, wherein the carbon nanochains are synthesized using a laser.

5. The method of claim 1, wherein the cathode is formed by drop casting, slurry coating, dry coating, spraying, molding, or pressing.

6. The method of claim 1, wherein the metal salt is one of an iron halide, a nickel halide, a cobalt halide, or a copper halide.

7. The method of claim 1, wherein the cellulose or lignocellulose source is one of biomass or isolated cellulose.

8. The method of claim 1, wherein the cathode has an increased discharge capacity compared to a second cathode synthesized from carbon nanochains or multi-walled carbon nanotubes without the presence of the other.

9. The method of claim 1, wherein the cathode has an increased cycle life compared to a second cathode synthesized from carbon nanochains or multi-walled carbon nanotubes without the presence of the other.

10. The method of claim 1, wherein the cathode is configured for use in a Li—O₂ battery.

11. A cathode comprised of:
one or more carbon nanochains using a cellulose or lignocellulose source and a metal salt; and
one or more multi-walled carbon nanotubes;
wherein the cathode is formed by mixing the one or more carbon nanochains with the one or more multi-walled carbon nanotubes and applying the mixture of carbon nanochains and the multi-walled carbon nanotubes to a surface to form a layer;
wherein the carbon nanochains are distributed within or adjacent to the carbon nanotubes.

12. The cathode of claim 11, wherein the carbon nanochains have an average pore diameter ranging from 1-200 nm.

13. The cathode of claim 11, wherein the carbon nanochains are synthesized in a furnace.

14. The cathode of claim 11, wherein the carbon nanochains are synthesized using a laser.

15. The cathode of claim 11, wherein the cathode is formed by drop casting, slurry coating, dry coating, spraying, molding, or pressing.

16. The cathode of claim 11, wherein the metal salt is one of an iron halide, a nickel halide, a cobalt halide, or a copper halide.

17. The cathode of claim 11, wherein the cellulose or lignocellulose source is one of biomass or isolated cellulose.

18. The cathode of claim 11, wherein the cathode has an increased discharge capacity compared to a second cathode synthesized from carbon nanochains or multi-walled carbon nanotubes without the presence of the other.

19. The cathode of claim 11, wherein the cathode has an increased cycle life compared to a second cathode synthesized from carbon nanochains or multi-walled carbon nanotubes without the presence of the other.

20. The cathode of claim 11, wherein the cathode is configured for use in a Li—O₂ battery.
